(19) United States
(12) Patent Application Publication
(10) Pub. No.: US 2008/0202682 A1
(43) Pub. Date: Aug. 28, 2008

(54) Heat-Activatedly Bonding 2D Element

(75) Inventors: Marc Husemann, Hamburg (DE); Frank Hannemann, Hamburg (DE)

Correspondence Address: Mark D. Marin;Norris McLaughlin & Marcus, PA, 875 Third Avenue, 18th Floor, New York, NY, 10022, US

(73) Assignee: TESA AG, Hamburg (DE)

(21) Appl. No.: 11/734,976

(22) Filed: Apr. 13, 2007

(30) Foreign Application Priority Data
Feb. 28, 2007 (DE) 10 2007 010 171.8

(51) Int. Cl. B32B 1/00; B32B 33/00; B65C 9/25

(52) U.S. Cl. 156/320; 428/178; 428/40.1

(57) ABSTRACT

The invention provides a substantially two-dimensional element (2D element) which bonds adhesively without bubbles under heat activation and has at least one heat-activable adhesive, one side face of said element having a groove element. The groove element comprises at least one groove adapted for the transport of a fluid. The groove is set into the side face of the 2D element in such a way that it is open towards the side face. It runs continuously from one edge section of the side face to a further edge section of the side face. By way of the groove structure formed from the at least one groove, liquid or gaseous fluids which form or collect in the bond area can be drained from the plane of the bond, thereby improving the strength of the bond. The invention further offers methods of producing and employing this 2D element.

The invention relates to a substantially two-dimensional element (“2D element”) which bonds adhesively without bubbles under heat activation and has at least one heat-activable adhesive having at least one side face which is oriented parallel to the principal extent of the 2D element and is adapted for the adhesive bonding of the 2D element to a substrate, and also to a method of producing a 2D element of this kind which bonds adhesively without bubbles under heat activation. The invention further relates to a method of producing a bubble-free bond by means of a 2D element of this kind which bonds adhesively without bubbles under heat activation.

Workpieces are frequently joined using adhesive bonds which produce joins whose properties can be tailored through the choice of adhesives employed. Typical of such applications is the use of single-sidedly or double-sidedly adhesive 2D elements such as, for instance, adhesive labels, adhesive tapes, adhesive sheets and the like. On one side face or on both side faces, adhesive articles of this kind have layers of adhesives, in other words two-dimensional adhesive coatings or adhesive films, which are intended to attach the adhesive article to the substrate, in other words to the base or to the bonding surface. A consequence of the use of highly specific adhesives, however, is that many of the systems used as adhesives require special processing measures in order for the desired bond to be actually obtainable.

For instance, for joins which are exposed to high loads, including those exposed to high loads at high temperatures, it is preferred to employ those adhesives which at room temperature have no inherent tack but which instead, only when exposed to heat, develop the bond strength to the substrates that is required for an adhesive bond. Heat-activable adhesives of this kind are frequently in solid form at room temperature and in the course of bonding, as a result of temperature exposure and also, if appropriate, of additional pressure, can be converted either reversibly or irreversibly into a state of high bond strength. Reversible heat-activable adhesives are those, for instance, based on thermoplastic polymers, whereas irreversible adhesives employed include, for example, reactive adhesives, in which thermally activable chemical reactions occur, crosslinking reactions for instance, with the consequence that these adhesives are suitable in particular for the permanent high-strength bonding of substrates.

A feature common to all of these heat-activable adhesive systems is that for adhesive bonding they must be heated strongly. Under these conditions, however, gaseous or liquid substances are frequently released within the adhesive layer, such as water, for instance, including water vapour, or air, which may come about, for instance, as by-products of a crosslinking reaction, in the course for example of a condensation reaction, or which are adsorbed in the polymer matrix at room temperature and undergo desorption on heating. The quantities of gaseous or liquid fluid released in this way are in some cases considerable: for instance, heat-activable adhesives based on copolyamides may contain water in a fraction of several percent by mass, which is adsorbed on the macromolecular network and may escape on heating.

Since the fluid is in each case released in the context of equilibrium reactions, it is unable to escape all at once, but instead is generated within the adhesive throughout the adhesive bonding process, and then collects at the bond plane between the adhesive and the substrate, in other words at the bond face. The collections of fluid appear there mostly in the form of bubble-like inclusions, which reduce the size of the bond area and also lift the adhesive mechanically, thereby resulting in a reduction overall in the strength of the adhesive bond. The thicker the layering of adhesive applied to the substrate, and the greater the amount of fluid which is therefore formed on activation, of course, the more pronounced the impairment of the bonding stability.

Fluid inclusions and fluid bubbles of this kind are therefore unwanted in the majority of adhesive bonds. A bubble-free (i.e. full-area) join is particularly important in the case of those bonds of which a technically uniform height is required, for which the visual quality of the bond is of importance, or which require uniformly high stability of the bond under load. To date, however, there have been no heat-activatedly bonding 2D elements known which allow high-strength bubble-free adhesive bonding in a simple way and do so even at high temperatures.

It is an object of the present invention, therefore, to provide a heat-activatedly adhesively bonding 2D element that eliminates these disadvantages and that ensures, in particular, bubble-free adhesive bonding in a simple way.

This object is achieved in accordance with the invention by means of a 2D element of the type specified at the outset, where the side face has a groove element which comprises at least one groove adapted for the transport of a fluid, the at least one groove being set into the side face in such a way that it is open towards the side face and runs continuously from one edge section of the side face to a further edge section of the side face.

The 2D element has a flat design, by which is meant that its height extent is low in relation to one or both side extents. For instance, in the case of a 2D element in filament form, its length is substantially greater than its height and its width; in the case of a 2D element in tape form, its length and width are substantially greater than its height, and in addition its length is greater than its width; and in the case of a sheet-like or label-like 2D element, its length and width are substantially greater than its height, the order of magnitude of the length and width being approximately the same. The plane of the 2D element along its length and width corresponds here to the principal extent of the 2D element. Hence a 2D element of this kind generally has two side faces which are oriented parallel to the principal extent of the 2D element.

On at least one of these two side faces there is an adhesively bondable 2D element with an adhesive layer whose outer side is joined to the substrate. The adhesive layer comprises at least one heat-activable adhesive which in the activated state at the activation temperature, at a temperature above room temperature, is capable of developing a high bond strength to the surface of the substrate, and which retains this high bond strength after activation, even at temperatures below the activation temperature, such as at room temperature, for example. In a bond of the 2D element to the substrate, the side face is then in direct contact with the surface of the substrate and together with this part of the substrate forms the area of the adhesive bond, in other words the bond plane.

Provided in accordance with the invention, then, is one particular design of one side face of the 2D element, featuring the disposal thereon of at least one groove element. If a gaseous or liquid fluid is located between the adhesive layer and the substrate, and forms a bubble, then the groove element makes it possible to move this fluid from the inside of the bond plane towards its edge. The transport of fluid (i.e. the removal of the fluid) from the bond plane is achieved by the generation of a pressure difference between the inside and the outside of the fluid-filled bubble, in the form, for instance, of an external pressure in the course of spreading, as a result of the inherent tension of the adhesive layer or of an additional backing, or when a vacuum is applied to the volume outside the bubble. As a result of this difference in pressure, the fluid present in the bubble within the groove element is removed in the direction of the location with the lower overall pressure.

For this purpose the groove element comprises at least one groove which, in the bond plane, extends parallel to the principal extent and is adapted for the transport of the fluid via this groove, so that the fluid can be transported via the groove even when the 2D element has been bonded to the substrate, without the 2D element lifting and the development there of a local separation of the bond. For this purpose the at least one groove is set openly into the side face and is therefore exposed towards the side face, so that any collections of fluid which are located in the boundary area between the substrate and the 2D element enter the groove and so can also be transported via this groove towards the edge of the 2D element. Additionally, the at least one groove runs continuously from one edge section of the side face to another edge section of the side face, so that the fluid transported to the edge of the 2D element is able to leave the groove at one edge region and in that way is removed simply and permanently from the bond plane.

In one advantageous embodiment the groove element has a multiplicity of grooves. In this way it is possible to drain a large quantity of fluid rapidly and with particular simplicity from the bond plane between the adhesive and the substrate at the edge of the 2D element. This is advantageous when, for instance, a relatively large amount of fluid forms or collects in the bond plane within a short period of time, and must therefore be removed rapidly so as not permanently to impair the strength of the bond overall.

In this case it is of advantage if the grooves are connected to one another via one or more intersections. Hence it is possible to ensure extremely efficient transport of the fluid from the bond plane, using the shortest transport routes in each case, these routes resulting as the route with lower flow resistances when the bond is spread.

It is advantageous, furthermore, for the grooves to have a substantially identical depth and a substantially identical width. This produces a heat-activatedly adhesively bonding 2D element which is particularly evenly load-bearing, thereby preventing one site tearing preferentially if the 2D element is unevenly loaded.

If, in contrast, an even load-bearing capacity is not the primary concern, it is of course also possible for the grooves to have different depths and/or different widths, so that the 2D element contains, for instance, very small, small, medium-sized, large, and very large grooves. It is true that the introduction of grooves having very large dimensions produces mechanically less load-bearing sections on the 2D element, at which the 2D element tears preferentially under uneven loading, and which would not be the case with an arrangement of uniformly medium-sized grooves. Nevertheless, it is possible in this way to obtain a 2D element which ultimately is stable, since it is possible overall to minimize the number of medium-sized, large and very large grooves. This is possible, for instance, with a dendrimeric design of the groove element, in which a large number of very small grooves remove the fluid from the adhesive to a smaller number of small grooves, which open out into an even smaller number of medium-sized grooves, which in turn allow draining into a few large grooves, via which the fluid is then able to pass to the individual, very large grooves, from which it leaves the 2D element at the edge sections.

It is advantageous, furthermore, if the width of a groove is at least 100 nm and not more than 2 mm. The use of grooves with widths of more than 2 mm impairs the load-bearing capacity of the adhesive bond excessively, even in the case of large 2D elements with a bond area of several square metres, whereas, in the case of grooves with widths of less than 100 nm, the pressure that is needed for fluid transport climbs to a disproportionately high extent. In systems of this kind, owing to the interaction with the groove walls, which is sizable in the case of small groove cross-sections, it is not possible for a laminar flow profile to develop. Moreover, with customary manufacturing techniques, the formation of such small structures is complicated and hence not economically rational.

The heat-activatedly adhesively bonding 2D element is especially suitable if the total area of the groove element in the side face makes up more than 2% of the total area of the side face and not more than 65% of the total area of the side face, preferably more than 5% of the total area of the side face. If the groove element has a total area of less than 2% of the total area of the side face, then overall there are only a few grooves having a low width, so that the transport capacity of the groove element overall is very low and the fluid cannot be drained rapidly from the bond plane. A significant reduction in the pressure to be applied for the purpose of fluid transport is observed for a total groove element area of more than 5% of the total area of the side face. If, however, the total area of the groove element is more than 65% of the total area of the side face, the adhesion of the 2D element to the substrate is very low.

The 2D element may comprise, moreover, a permanent backing. This gives the 2D element overall a high level of robustness in the face of mechanical exposures.

Furthermore, the 2D element may have a second side face which is disposed opposite the above-described side face, is oriented parallel to the principal extent of the 2D element, and, moreover, is adapted for adhesive bonding of the 2D element to a second substrate. This second side face may have a second groove element which comprises at least one groove adapted for the transport of the fluid, which is set into the second side face in such a way that it is open towards the second side face and runs continuously from one edge section of the second side face to a further edge section of the second side face. In this way, a double-sidedly adhesively bondable 2D element is obtained in which both adhesive layers each have a groove element for removal of fluid from the bond planes, so that, in this way, it is possible to obtain 2D elements which bond adhesively without bubbles on both sides.

It is advantageous, furthermore, if the 2D element comprises a temporary backing which has a raised ridge element which is shaped complementarily to the at least one groove and which engages into the at least one groove. When the 2D element is stored in unison with a complementary backing of this kind, a design of this nature ensures that the functionality of the groove element in the adhesive layer is retained even at relatively high temperatures. In the presence of the temporary backing, there can be no creeping of adhesive into the grooves, and the groove element thus remains continuous.

This design has the effect, moreover, of simplifying the production of the groove element in the adhesive layer, allowing the groove element to be produced in a shaping step with the assistance of the temporary backing. Hence this design also provides a particularly simple method of producing the 2D element which bonds adhesively without bubbles under heat activation, in which a heat-activable adhesive is applied to one top side of the temporary backing in such a way that, when the adhesive is applied to the temporary backing, the ridge elements on the top side of the temporary backing form, in the adhesive, the groove element shaped complementarily to the ridge elements, and, in so doing, engage in the at least one groove of the groove element. In this way, using the temporary backing and the ridge elements disposed thereon as a casting mould or embossing die, the groove element can be produced in the adhesive layer of the 2D element in a simple way, without any need to carry out separate structuring steps on the adhesive layer.

Particularly advantageous, in the case of the production of a double-sidedly adhesively bondable 2D element, is the use of a temporary backing provided likewise double-sidedly with ridge elements, since in this way the above production method can be simplified even more. In this case, the second groove element can be impressed onto the second side of the 2D element, again without a separate structuring step, in that concludingly the 2D element, joined temporarily at one side to the temporary backing, is wound up into a roll, for the purpose of storage, in such a way that on the second side face of the 2D element the heat-activable adhesive is pressed against a second ridge element on a second top side of the temporary backing, disposed opposite the above-described top side, and such that the second groove element, shaped complementarily to the second ridge element, is impressed into the adhesive and engages into the at least one groove of the second groove element.

Proposed in accordance with a further aspect of the present invention, accordingly, is a method of producing a bubble-free adhesive bond by means of the above-described 2D element which bonds adhesively without bubbles under heat activation. To date it has been customary to convey the fluid accumulating in the bond plane towards the edge of the 2D element under strong pressure. This method has a number of practical drawbacks, since the pressure that has to be applied for fluid transport must be large enough to part the adhesive bond locally in the hot state briefly, during the passage of the fluid, and then to re-form the bond, the adhesion of the 2D element to the substrate then often being poorer. It is a further object of the invention, therefore, to provide a method that eliminates the said drawbacks and that permits, in particular, simplified fluid transport along the plane of the bond without an accompanying reduction in bond strength.

This object is achieved by means of a method wherein in a hot lamination step the 2D element is applied under pressure to the substrate in such a way that fluid enclosed in the bond area between the 2D element and the substrate is drained from the bond area via the groove element. Using the groove element allows the fluid to exit even under slight pressure. Local parting of the adhesive bond already obtained is no longer necessary.

A 2D element which bonds adhesively without bubbles under heat activation is understood in the present case to be any sheetlike structure which is designed for heat-activated bonding and is also adapted for a bubble-free join. A bubble-free join in the present case is any full-area adhesive bond to a substrate where there are no bubbles present in the bond plane, this situation being achievable without aftertreatment, or at most with very simple aftertreatment.

The 2D element of the invention is adapted for the adhesive bonding of the 2D element to the substrate at least at one of the two side faces aligned parallel to the principal extent of the 2D element, and if appropriate at both side faces. An adaptation of this kind encompasses any measure needed for adhesive bonding: for instance, the disposing of an adhesive directly and accessibly on this side face, and also the selection of an adhesive and coating of adhesive that are tailored to the specific substrate, something which can be achieved, for instance, by a thickness of the adhesive layer that is sufficient in relation to the roughness of the substrate surface, or by an adhesive composition which is adapted to develop a high bond strength to the substrate.

Suitable heat-activable adhesives in this case are all customary heat-activable adhesives. Adhesives of this kind may have different polymer structures. Described hereinbelow, purely by way of example, are a number of typical heat-activable adhesive systems which have been found to be particularly advantageous in connection with the present invention, specifically those adhesive systems that are based on polyacrylates, on polyolefins, and on elastomeric base polymers and at least one modifier resin.

Heat-activable adhesives based on polyacrylates and/or polymethacrylates (referred to below for short as “poly(meth)acrylates”) comprise as principal monomer, at 70% to 100% by weight, an acrylic ester and/or methacrylic ester and/or a free acid of these compounds, having the general formula CH₂═C(R¹)(COOR²), where R¹ is selected from the group encompassing H and CH₃ and R² is selected from the group encompassing H and/or alkyl chains having 1 to 30 C atoms. Monomers of this kind are, for instance, acrylic monomers, comprising acrylic and methacrylic esters with alkyl groups consisting of 1 to 14 C atoms. Specific examples that may be given of such monomers, without wishing to be restricted as a result of this enumeration, include methyl acrylate, methyl methacrylate, ethyl acrylate, ethyl methacrylate, propyl acrylate, propyl methacrylate, n-butyl acrylate, n-butyl methacrylate, n-pentyl acrylate, n-hexyl acrylate, n-hexyl methacrylate, n-heptyl acrylate, n-octyl acrylate, n-nonyl acrylate, lauryl acrylate, stearyl acrylate, stearyl methacrylate, behenyl acrylate, and also their branched isomers, for example 2-ethylhexyl acrylate. Further useful monomers which are likewise suitable in small amounts as an addition to the principal monomer are cyclohexyl methacrylate, isobornyl acrylate and isobornyl methacrylate.

Polymers of this kind may optionally contain as further monomers, at not more than 30% by weight, olefinically unsaturated monomers having additional functional groups, and having the general formula CH₂═C(R³)(COOR⁴), where R³ is selected from the group encompassing H and/or CH₃ and OR² is a functional group or at least contains a functional group which supports subsequent crosslinking of the adhesive on exposure to ultraviolet light, by virtue, for instance, of this functional group having an H donor effect.

Examples of further monomers of this kind are hydroxyethyl acrylate, hydroxypropyl acrylate, hydroxyethyl methacrylate, hydroxypropyl methacrylate, allyl alcohol, maleic anhydride, itaconic anhydride, itaconic acid, acrylamide and glyceridyl methacrylate, benzyl acrylate, benzyl methacrylate and phenyl acrylate, phenyl methacrylate, tert-butylphenyl acrylate, tert-butylphenyl methacrylate, phenoxyethyl acrylate, phenoxyethyl methacrylate, 2-butoxyethyl methacrylate, 2-butoxyethyl acrylate, dimethylaminoethyl methacrylate, dimethylaminoethyl acrylate, diethylaminoethyl methacrylate, diethylaminoethyl acrylate, cyanoethyl methacrylate, cyanoethyl acrylate, glyceryl methacrylate, 6-hydroxyhexyl methacrylate, N-tert-butylacrylamide, N-methylolmeth-acrylamide, N-(butoxymethyl)methacrylamide, N-methylolacrylamide, N-(ethoxymethyl)-acrylamide, N-isopropylacrylamide, vinylacetic acid, tetrahydrofurfuryl acrylate, β-acryloyl-oxypropionic acid, trichloroacrylic acid, fumaric acid, crotonic acid, aconitic acid and dimethylacrylic acid, this enumeration not being exhaustive.

Other examples of such further monomers are, for instance, aromatic vinyl compounds, it being possible for the aromatic nuclei to be composed preferably of C4 to C18 units and also to contain heteroatoms, such as styrene, 4-vinylpyridine, N-vinylphthalimide, methylstyrene, 3,4-dimethoxystyrene or 4-vinylbenzoic acid, this enumeration again being not exhaustive.

For the polymerization the monomers are selected such that the resulting polymers can be used as heat-activable adhesives. For the present requirements, for instance, a polymer results that has a static glass transition temperature T_{g,A} of more than 30° C.

In accordance with the foregoing, a glass transition temperature T_{g,A} of this kind, of at least 30° C., is obtained by selecting the monomers and the quantitative composition of the monomer mixture in such a way as to give the desired T_{g,A} value for the polymer in accordance with equation (E1), in analogy to the equation presented by Fox (cf. T. G. Fox, Bull. Am. Phys. Soc. 1 (1956) 123), as follows:

$$\frac{1}{{T}_{g}} = {\sum }_{n} \frac{{W}_{n}}{{T}_{g , n}} . \qquad ( E 1 )$$

In this equation, n represents the serial number of the monomers used, wₙ the mass fraction of the respective monomer n (in % by weight), and T_{g,n} the respective glass transition temperature of the homopolymer of the respective monomer n (in K).

Instead of acrylate-based adhesives of this kind it is also possible for the adhesives to be based on polyolefins, particularly on poly-α-olefins whose softening range lies above 30° C. and which resolidify in the course of cooling after bonding. Polyolefin-based adhesives of this kind have static glass transition temperatures T_{g,A} or melting points T_{m,A}, for instance, from a range between 35° C. and 180° C. The bond strength of these polymers can be increased still further by means of targeted additization. Thus it is possible for this purpose to use polyimine copolymers or polyvinyl acetate copolymers, for example, as bond strength-promoting additions.

In order to achieve the desired static glass transition temperature T_{g,A} or the melting point T_{m,A}, the monomers employed and also their quantities are again selected here so as to give the desired temperature value for the polymer in accordance with equation (E1) in analogy to the equation presented by Fox.

For greater ease of handling, the static glass transition temperature T_{g,A} or the melting point T_{m,A} for the heat-activable adhesive is also restricted further. If the temperature is too low, there is a risk of the 2D element softening at elevated temperatures during delivery or during transport, and becoming fused to underlying webs, with the result that the 2D element is no longer detachable.

To determine the optimum temperature range for this purpose, it is possible to vary the molecular weight and also the composition of the comonomers. In order to set a low static glass transition temperature T_{g,A} or a low melting point T_{m,A}, use is made, for example, of polymers having a medium or low molecular weight. It is also possible in this case to blend low molecular weight with high molecular weight polymers. In this context, the use of polyethenes, polypropenes, polybutenes, polyhexenes or copolymers of these polymers has been found to be advantageous.

Polyethylene and copolymers of polyethylene can be applied, for example, as aqueous dispersions in the form of a layer. The composition of the particular blend to be used is dependent in turn on the desired static glass transition temperature T_{g,A} or the desired melting point T_{m,A} of the resultant heat-activable adhesive.

As poly-α-olefins, various heat-activable polymers are available from the company Degussa under the trade name Vestoplast™. Propene-rich polymers are offered under the designations Vestoplast™ 703, 704, 708, 750, 751, 792, 828, 888 and 891. They have melting points T_{m,A} from a range from 99 to 162° C. Butene-rich polymers are available under the designations Vestoplast™ 308, 408, 508, 520 and 608. They possess melting points T_{m,A} from a range from 84 to 157° C.

Further examples of heat-activable pressure-sensitive adhesives are disclosed in U.S. Pat. Nos. 3,326,741, 3,639,500, 4,404,246, 4,452,955, 4,404,345, 4,545,843, 4,880,683 and 5,593,759. These documents also describe other temperature-activable pressure-sensitive adhesive systems.

Alternatively a heat-activable adhesive can be designed on the basis of elastomeric base polymers and at least one modifier resin. As elastomeric base polymer it is possible to employ all suitable elastomeric polymers, examples being rubbers, nitrile rubbers, epoxidized nitrile rubbers, polychloroisoprenes and polyacrylates. The rubbers may be natural rubbers or synthetic rubbers. Suitable synthetic rubbers are all customary synthetic rubber systems, such as those based on polyvinylbutyral, polyvinylformal, nitrile rubbers, nitrile-butadiene rubbers, hydrogenated nitrile-butadiene rubbers, polyacrylate rubbers, chloroprene rubbers, ethylene-propylene-diene rubbers, methyl-vinyl-silicone rubbers, fluorosilicone rubbers, tetrafluoroethylene-propylene copolymer rubbers, butyl rubbers or styrene-butadiene rubbers. The synthetic rubbers are customarily selected such that they have a softening temperature or glass transition temperature from a temperature range from −80° C. to 0° C.

Commercially customary examples of nitrile-butadiene rubbers are, for instance, Europrene™ from Eni Chem, or Krynac™ from Bayer, or Breon™ and Nipol N™ from Zeon. Polyvinylformals can be had, for instance, as Formvar™ from Ladd Research. Polyvinylbutyrals are available as Butvar™ from Solutia, as Pioloform™ from Wacker and as Mowital™ from Kuraray. Hydrogenated nitrile-butadiene rubbers available include, for example, the products Therban™ from Bayer and Zetpol™ from Zeon. Polyacrylate rubbers are in commerce for example as Nipol AR™ from Zeon. One instance of chloroprene rubbers available is Baypren™ from Bayer. Ethylene-propylene-diene rubbers can be acquired, for example, as Keltan™ from DSM, as Vistalon™ from Exxon Mobil and as Buna EP™ from Bayer. Methyl-vinyl-silicone rubbers are available, for instance, as Silastic™ from Dow Corning and as Silopren™ from GE Silicones. Fluorosilicone rubber as well is suitable, for example Silastic™ from GE Silicones. Butyl rubbers are available for instance as Esso Butyl™ from Exxon Mobil. Possibly serving as styrene-butadiene rubbers are, for instance, Buna S™ from Bayer, Europrene™ from Eni Chem and Polysar S™ from Bayer.

In addition to the purely elastomeric polymers it is also possible to use blends of thermoplastic polymers with elastomeric base polymers. Thermoplastic materials are selected preferably from the group of the following polymers: polyurethanes, polystyrenes, acrylonitrile-butadiene-styrene terpolymers, polyesters, unplasticized polyvinyl chlorides, plasticized polyvinyl chlorides, polyoxymethylenes, polybutylene terephthalates, polycarbonates, fluorinated polymers such as polytetrafluoroethylene, for instance, polyamides, ethylene-vinyl acetates, polyvinyl acetates, polyimides, polyethers, copolyamides, copolyesters, polyolefins such as, for instance, polyethylene, polypropylene, polybutene, polyisobutene and poly(meth)acrylates. This enumeration as well makes no claim to completeness. The thermoplastic polymers are typically selected so as to have a softening temperature or glass transition temperature from a temperature range from 60° C. to 125° C.

Resins which may serve as modifier resins are all those which influence the adhesive properties of the adhesive, especially bond strength-increasing resins and reactive resins. As bond strength-increasing resin it is possible to use all known tackifier resins. The fraction of the modifier resins as a proportion of the adhesive is typically between 25% and 75% by weight, based on the mass of the overall blend of elastomeric polymer and modifier resin.

As bond strength-increasing resins or tackifying resins—tackifier resins, as they are referred to—it is possible without exception to use all of the tackifier resins that are known and are described in the literature, examples being pinene resins, indene resins and rosins, their disproportionated, hydrogenated, polymerized and esterified derivatives and salts, the aliphatic and aromatic hydrocarbon resins, terpene resins and terpene-phenolic resins, and C5 resins, C9 resins and other hydrocarbon resins. These and further resins may be used individually or in any desired combinations in order to adjust the properties of the resultant adhesive in accordance with requirements. Generally speaking, it is possible to use any resins that are compatible (soluble) with the thermoplastic material in question, especially aliphatic, aromatic or alkylaromatic hydrocarbon resins, hydrocarbon resins based on single monomers, hydrogenated hydrocarbon resins, functional hydrocarbon resins, and natural resins. Reference may be made explicitly to the depiction of the state of knowledge in the “Handbook of Pressure Sensitive Adhesive Technology” by Donatas Satas (van Nostrand, 1989).

The adhesive may further comprise a reactive resin, which is capable of crosslinking with itself, with other reactive resins and/or with the at least one nitrile rubber in the adhesive. Within an adhesive, reactive resins influence the adhesive properties of the said adhesive as a consequence of chemical reactions. As reactive resins it is possible in the present case to use all customary reactive resins, examples being epoxy resins, phenolic resins, terpene-phenolic resins, melamine resins, resins with isocyanate groups, or blends of these resins.

The epoxy resins encompass the entire group of epoxide compounds. Hence the epoxy resins may be monomers, oligomers or polymers. Polymeric epoxy resins may be aliphatic, cycloaliphatic, aromatic or heterocyclic in nature. The epoxy resins typically have at least two epoxide groups which can be utilized for crosslinking.

The molecular weight of the epoxy resins varies from 100 g/mol up to a maximum of 10 000 g/mol for polymeric epoxy resins.

The epoxy resins encompass all typical epoxides, such as the reaction product of bisphenol A and epichlorohydrin, the reaction product of phenol and formaldehyde (known as novolak resins) and epichlorohydrin, glycidyl esters or the reaction product of epichlorohydrin and p-aminophenol.

Epoxy resins of this kind are available commercially, in the form for example of Araldite™ 6010, CY-281 ™, ECN™1273, ECN™1280, MY 720, RD-2 from Ciba Geigy, in the form of DER™ 331, DER™ 732, DER™ 736, DEN™ 432, DEN™ 438, DEN™ 485 from Dow Chemical, in the form of Epon™ 812, 825, 826, 828, 830, 834, 836, 871, 872, 1001, 1004, 1031 etc., and in the form of HPT™1071, HPT™1079, the latter from Shell Chemical.

Examples of commercial aliphatic epoxy resins are, for example, vinylcyclohexane dioxides such as ERL-4206, ERL-4221, ERL 4201, ERL-4289 or ERL-0400 from Union Carbide Corp.

Examples of novolak resins which can be used include Epi-Rez™ 5132 from Celanese, ESCN-001 from Sumitomo Chemical, CY-281 from Ciba Geigy, DEN™ 431, DEN™ 438, Quatrex 5010 from Dow Chemical, RE 305S from Nippon Kayaku, Epiclon™ N673 from DaiNippon Ink Chemistry or Epikote™ 152 from Shell Chemical.

As phenolic resins it is possible to use conventional phenolic resins, such as YP 50 from Toto Kasei, PKHC from Union Carbide Corp. or BKR 2620 from Showa Union Gosei Corp. As reactive resins it is also possible to use phenolic resole resins, alone or in combination with other phenolic resins. As terpene-phenolic resins it is possible to use all customary terpene-phenolic resins, for example NIREZ™ 2019 from Arizona Chemical. As melamine resins it is possible to use all customary melamine resins, examples being Cymel™ 327 and 323 from Cytec. As resins with isocyanate groups, use may be made of customary resins functionalized with isocyanate groups, examples being Coronate™ L from Nippon Polyurethane Ind., Desmodur™ N3300 or Mondur™ 489 from Bayer.

To accelerate the reaction between the two components, the adhesive may optionally also include crosslinkers and accelerants. Suitable accelerants are all of the appropriate accelerants that are known to the skilled worker, such as imidazoles, available commercially as 2M7, 2E4MN, 2PZ-CN, 2PZ-CNS, P0505 and L07N from Shikoku Chem. Corp. and as Curezol 2MZ from Air Products, and also amines, especially tertiary amines. Suitable crosslinkers include all of the appropriate crosslinkers that are known to the skilled worker, an example being hexamethylenetetramine (HMTA).

Additionally the adhesive may optionally also include further constituents, examples being plasticizers, fillers, nucleators, expandants, bond strength enhancer additives and thermoplastic additives, compounding agents and/or ageing inhibitors.

Plasticizers which can be used are all of the suitable plasticizers known to the skilled person, examples being those based on polyglycol ethers, polyethylene oxides, phosphate esters, aliphatic carboxylic esters and benzoic esters, aromatic carboxylic esters, relatively high molecular weight diols, sulfonamides and adipic esters.

As fillers it is possible to use all suitable fillers known to the skilled person, examples being fibres, carbon black, metal oxides such as zinc oxide and titanium dioxide, chalk, silica, silicates, solid beads, hollow beads or microbeads made of glass or other materials.

As ageing inhibitors it is possible to use all suitable ageing inhibitors known to the skilled person, examples being those based on primary and secondary antioxidants or light stabilizers.

As bond strength enhancer additives it is possible to use all suitable bond strength enhancer additives known to the skilled person, examples being polyvinylformal, polyvinylbutyral, polyacrylate rubber, chloroprene rubber, ethylene-propylene-diene rubber, methyl-vinyl-silicone rubber, fluorosilicone rubber, tetrafluoroethylene-propylene copolymer rubber, butyl rubber or styrene-butadiene rubber.

Polyvinylformals can be had, for instance, as Formvar™ from Ladd Research. Polyvinylbutyrals are available as Butvar™ from Solutia, as Pioloform™ from Wacker and as Mowital™ from Kuraray. Polyacrylate rubbers are available as Nipol AR™ from Zeon. Chloroprene rubbers are available as Baypren™ from Bayer. Ethylene-propylene-diene rubbers are available as Keltan™ from DSM, as Vistalon™ from Exxon Mobil and as Buna EP™ from Bayer. Methyl-vinyl-silicone rubbers are available as Silastic™ from Dow Corning and as Silopren™ from GE Silicones. Fluorosilicone rubbers are available as Silastic™ from GE Silicones. Butyl rubbers are available as Esso Butyl™ from Exxon Mobil. Styrene-butadiene rubbers are available as Buna S™ from Bayer, as Europrene™ from Eni Chem and as Polysar S™ from Bayer.

As thermoplastic additives it is possible to use all suitable thermoplastics known to the skilled person, examples being thermoplastic materials from the group of polyurethanes, polystyrene, acrylonitrile-butadiene-styrene terpolymers, polyesters, unplasticized polyvinyl chlorides, plasticized polyvinyl chlorides, polyoxymethylenes, polybutylene terephthalates, polycarbonates, fluorinated polymers such as polytetrafluoroethylene, for instance, polyamides, ethylene-vinyl acetates, polyvinyl acetates, polyimides, polyethers, copolyamides, copolyesters, poly(meth)acrylates, and also polyolefins such as polyethylene, polypropylene, polybutene and polyisobutene, for instance.

In addition, the bond strength of the heat-activatedly adhesively bonding 2D element can be increased by means of further targeted additization, such as through use of polyimine copolymers and/or polyvinyl acetate copolymers as bond strength-promoting additions.

In accordance with the invention the 2D element comprises at least one groove element on the side face. This groove element has one groove or two or more grooves, which may possess any desired expedient arrangements, so that at its most simple the groove element consists, therefore, of just a single groove. By groove is meant any channel-like indentation of substantially elongate design that is suitable for fluid removal. Accordingly, the groove cross-section may have any of the typical profiles, such as those of a semicircle, of a half-oval, of a triangle, of a rectangle or square, of a trapezium, an irregular shape or the like.

The groove or grooves in this case are set into the adhesive layer, so that the inner cavity of each groove is open at the side face and is accessible from the side face. In this way, any fluid present in the bond between the adhesive at the side face and the surface of the substrate is able to pass from there into the at least one groove directly.

The at least one groove runs continuously from one edge section of the side face to a further edge section of the side face. An edge section of the side face is any region in an outer edge side face of the 2D element that is disposed substantially perpendicular to the principal extent of the 2D element. Towards these edge side faces, a groove of this kind is not closed off by a wall, but instead is open. Consequently it is possible for any fluid to exit via the opening in the edge side face from the groove space formed by the groove and the substrate surface in the course of bonding, and so to leave permanently the 2D element and the bond plane. This arrangement is continuous from one edge section of the side face to a further end section of the side face, it being possible for the one edge section and the further edge section to be disposed at the same outer edge side face or else at different outer edge side faces.

A groove is regarded as being continuous for the purposes of this invention if fluid transport in the groove can take place from one end of the groove to a second end of the groove. At this second end, the fluid may then either leave the 2D element directly, or else is conveyed on into further grooves which are joined to the groove and via which the fluid can then leave the 2D element. The term “continuous” also embraces two or more grooves which are not joined to one another and have end sections ending blindly and through which fluid transport can admittedly take place only in each case to an open end of each groove, but where at least two different edge sections of the outer edge side faces of the 2D element do have such openings. The at least one groove must in this case only be continuous until any fluid, in the bonding of the 2D element to the substrate, has been removed from the bond plane, and a bubble-free bond has been obtained. After that, the groove may either continue to be continuous or else may become impassable, as a result, for instance, of undergoing complete or local blockage as a result of subsequent viscous flow of the adhesive.

With regard to the arrangement of two or more grooves, these grooves may have any desired, suitable geometries. By way of example, two or more grooves which run parallel to one another but are not joined to one another may form the groove element. Alternatively the groove element may be composed of a multiply branching groove which forms a dendrimeric or ramified groove system. Moreover, other arrangements of the grooves are likewise possible, so that, for example, net-like or lattice-like groove arrangements may also form a groove system in accordance with the invention. In latter cases, grooves are joined to one another via one or more intersections, so that the fluid conveyed via the groove element can pass from one groove into another groove. The groove element may of course also have two or more groove systems alongside one another.

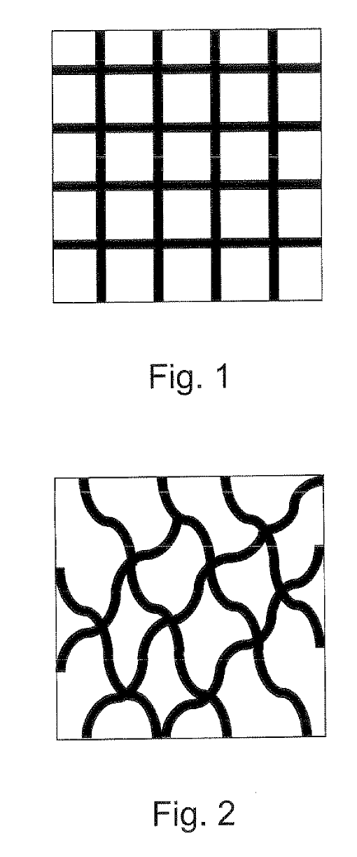

A number of typical examples of structures of a groove element in accordance with the invention are depicted diagrammatically in FIGS. 1 to 4. Of these figures,

FIG. 1 shows a first structure of the groove element,

FIG. 2 shows a second structure of the groove element,

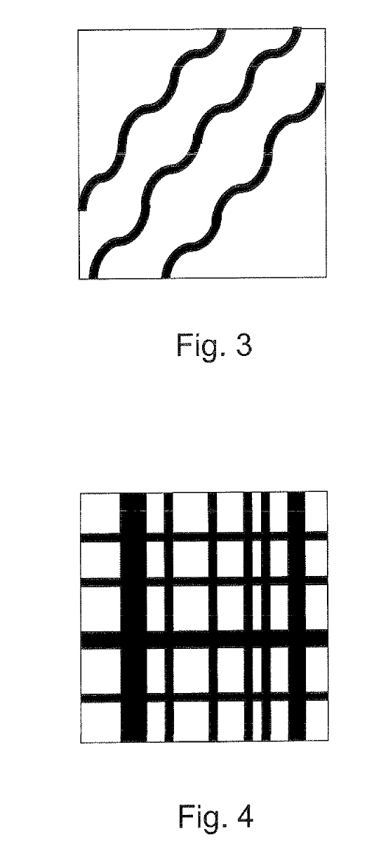

FIG. 3 shows a third structure of the groove element, and

FIG. 4 shows a fourth structure of the groove element.

The principal extent of the 2D element lies in each case parallel to the plane of representation, and the outer edge side faces of the rectangular 2D element are shown as thin outer bordering lines. The thicker black lines show in each case the arrangement of the grooves within the groove element, and the white areas therefore show the bonding regions of the side face of the 2D element that are in contact with the substrate.

In FIG. 1 a coherent lattice-like structure is shown, composed of a plurality of interconnected grooves which at the intersections meet at right angles to one another. All of the grooves in this structure have the same width.

FIG. 2 again depicts a coherent lattice-like structure composed of a plurality of interconnected grooves. The structure shown here is of irregular construction as compared with that from FIG. 1, and so the grooves meet one another at the intersections at different angles and distances with respect to one another. In this structure too, all of the grooves have the same width.

FIG. 3 represents a non-coherent structure composed of a plurality of individual grooves which are disposed in one preferential direction. This structure too is of irregular construction, and so the grooves regionally have partial curves with different radii of curvature. In this structure as well, all of the grooves have the same width.

Represented in FIG. 4 is a coherent lattice-like structure composed of a plurality of interconnected grooves which meet at right angles to one another at the intersections. In contrast to the structure from FIG. 1, however, the grooves in this structure have different widths.

These examples have been chosen merely by way of illustration, and are not intended to restrict the scope of the invention. For instance, groove elements in accordance with the invention may of course also be of trapezoidal, triangular or similar construction.

The grooves may have any desired suitable dimensions; for instance, the grooves may have a substantially identical depth and a substantially identical width, or else different grooves may possess different depths and/or different widths. The latter design encompasses systems having bimodal, trimodal or polymodal groove dimensions, in which there are two different, three different or a multiplicity of different groove cross-sections. It is possible, for instance, to produce groove systems having a main groove with a large cross-section and a plurality of smaller, secondary grooves, with smaller cross-sections, that open out into the main groove, the secondary grooves being fed in turn by secondary grooves with even smaller cross-sections, and so on, or else to produce groove systems having cross-sections which expand or taper towards the corresponding openings in the outer edge side faces. The maximum depth of a groove is restricted by the thickness of the adhesive layer, while the width of a groove is at least 100 nm and not more than 2 mm. With regard to the relative proportions of the total area of the side face of the 2D element and of the groove element set into it, the total area of the groove element situated at the side face ought to make up more than 2% of the total area of the side face of the 2D element and not more than 65% of the total area of the side face of the 2D element, preferably more than 5% of the total area of the side face.

The grooves must further be adapted for the transport of a fluid. Such adaptation embraces any required and/or effective measure which permits or improves the transport of fluid through the grooves of the groove element. Such measures may be, for example, an adaptation of the geometry of the groove, such as an adaptation of the dimensions of the groove or an adaptation of the shape of the cross-section of the groove, and also an adaptation of the nature of the groove walls. The latter is necessary, for instance, when for the purpose of activation it is necessary to heat the adhesive to such high temperatures that there is a sharp reduction in the viscosity of the adhesive. In these circumstances, without separate adaptation of the groove wall, in the form for instance of a coating or local precrosslinking of the adhesive only in the region of the groove wall, the groove cross-section would undergo a drastic reduction, since at these temperatures it is not possible to disregard viscous flow of the adhesive, which would make fluid transport via the groove element more difficult, if not indeed impossible.

Depending on the particular properties required, the 2D element may comprise a permanent backing or else may be of backing-free design. Backing-free design, in the form for instance of an adhesive transfer tape with two different adhesives or with only one adhesive, is sensible if the 2D element overall is to have an extremely low height, such as in the case of adhesive bonds in the miniature range. In contrast, the design with an additional backing is particularly favourable, for example, if particularly high mechanical stability is needed for the 2D element, in the case for instance of highly loaded bonds, and also for the purpose of improving diecuttability when 2D elements are used as diecuts. A permanent backing of this kind may be composed of any of the materials familiar to the skilled person, such as, for example, of polymers such as polyesters, polyethylene, polypropylene, including modified polypropylene such as biaxially oriented polypropylene (BOPP), polyamide, polyimide, polyvinyl chloride or polyethylene terephthalate, and also natural substances; these materials may be in the form of woven, knitted or laid fabrics, nonwovens, papers, foams, films and the like, or else combinations thereof, such as laminates or woven films.

To improve the adhesion it is possible when using a permanent backing for this backing to be provided on one or both sides with an adhesion promoter, referred to as a “primer”. As adhesion promoters of this kind it is possible to use typical primer systems, such as heat-sealing adhesives based on polymers such as ethyl-vinyl acetate or functionalized ethyl-vinyl acetates, or else reactive polymers. Functional groups which can be used are all typical adhesion-enhancing groups, such as epoxide, aziridine, isocyanate or maleic anhydride groups. It is also possible for additional crosslinking components to have been added to the adhesion promoters, examples being melamine resins or melamine-formaldehyde resins. Highly suitable adhesion promoters thus include those based on polyvinylidene chloride and copolymers of vinylidine dichloride, in particular with vinyl chloride (for instance, Saran from the Dow Chemical Company).

Furthermore, the 2D element may have been made adhesive either on one side or else on both sides; in other words, either only one of the side faces aligned parallel to the principal extent of the 2D element has been furnished with an adhesive layer, or else, additionally, the second side face has as well, the one located in the 2D element on the side opposite the one side face. The adhesives of the adhesive layers on the two side faces may in the latter case be identical or different, depending on the application and on the substrates to be joined. Accordingly, a 2D element of the invention could also represent an unbacked adhesive transfer tape, composed of a single adhesive in an adhesive layer. In accordance with the invention the second adhesive layer may likewise have a suitable groove element, in which case the design of the second groove element may be identical or different to that of the first groove element.

To produce a 2D element, the blended adhesive is applied to a backing. The adhesives may be applied directly to the 2D element—for instance, to a permanent backing or to another adhesive layer which has been spread out flatly. Alternatively, application may take place indirectly, with the use for instance of a temporary backing such as, for instance, an in-process liner or a release liner.

As temporary backing it is possible to use all of the temporary backings known to the skilled person, such as release films, release varnishes or release papers. Release films are, for example, reduced-adhesion films based on polyethylene, polypropylene (including oriented polypropylene such as biaxially oriented polypropylene, for instance), polyethylene terephthalate, polyethylene naphthalate, polyvinyl chloride, polyesters, polyimide or blends of these materials. Release varnishes may frequently be silicone varnishes or fluorinated varnishes for reducing adhesion. Release papers are all of the suitable release papers known to the skilled person, such as those based on polyethylene produced in high-pressure processes (LDPE), polyethylene produced in low-pressure processes (HDPE), glazed greaseproof or glassine paper. For further reduction in adhesion, the release agents may additionally have been furnished with a release layer. Materials suitable for a release layer are all customary materials known to the skilled person, such as silicone release varnishes or fluorinated release varnishes.

In selecting the suitable material for the temporary backing, account should be taken of an adequate heat resistance, so that in any further processing steps such as hot lamination, for instance, there is no damage to the temporary backing.

It is also sensible in this case for one of the two sides to be coated on such a release liner to have a lower release force than the other side, so that the adhesive adheres more effectively to the said one side. By this means it is possible, when unwinding 2D elements stored on rolls, to prevent transfer of the adhesive, since the adhesive detaches more readily from the other side than from the one side.

The application of the adhesive to the 2D element takes place by conventional methods and using customary apparatus, such as via a melt die or an extrusion die. In the course of this application, the 2D element is coated on one side in each case with the adhesive. A two-dimensional adhesive coating obtained in this way from the applied adhesive may cover the whole area of the 2D element on one side or else may only have been applied locally.

For instance, the adhesive may be applied from a solution. For dissolving it is preferred to use those solvents in which at least one of the components of the adhesive has a good solubility.

For application of the adhesive from the melt it is possible to strip off any solvent present, under reduced pressure in a concentrating extruder, for example. This can be done using, for example, single-screw or twin-screw extruders, which distil off the solvent in the same vacuum stage or in different vacuum stages and which, if appropriate, possess a feed preheater.

To produce a 2D element in a direct process it is possible for example in a first step to apply the adhesive to one side of a backing and in a second step to apply the same adhesive or a different adhesive to the other side of the backing. Alternatively, in a direct coating operation, the one adhesive can, for instance, also be applied in a first step to a release agent, and the same adhesive or another adhesive in a second coating step, from solution or from the melt, directly to the one adhesive, specifically to the side of the one adhesive that is not covered by the release agent. In this latter way an unbacked 2D element is obtained, an adhesive transfer tape for example.

In the case of an indirect application, both adhesives are first applied separately from one another to a temporary backing or a release agent, and are joined to one another only in a subsequent step. In order to obtain particularly efficient adhesion of the two coatings of adhesive to one another, it is possible in the last step to laminate two adhesive coatings, applied to temporary backings, directly to one another in a hot lamination process under pressure and temperature, such as by means of a hot roll laminator having one or two heated rolls.

It is of course also possible for both coatings of adhesive to be joined directly to one another or to a common backing in a joint process step, such as in a coextrusion procedure.

To produce greater layer thicknesses it is also possible, moreover, to join two or more adhesive layers to one another in a laminating step. A laminating step of this kind takes place typically with introduction of heat and pressure. The product may then be processed further as a double-liner product, in other words having temporary backings on both sides. Alternatively, one of the two temporary backings may be delaminated again.

In the case of the processes described above, the groove element can be made, in a concluding step, into the surface of the adhesive at the side face of the 2D element by means of conventional structuring techniques, such as via lithographic operations, wet-chemical etching, laser ablation, electroplating steps or a mechanical operation, such as in milling processes or embossing processes by means of external dies or embossing rolls.

It is particularly advantageous, though, for the groove element to be transferred to the heat-activable adhesive via a corresponding inverse or complementary design of the temporary backing. A temporary backing of this kind has a raised ridge element designed complementarily to the at least one groove and engages in the at least one groove. By pressing the complementarily designed temporary backing onto a flat unstructured adhesive layer, the groove element is then impressed into the side face of the 2D element. Alternatively, the adhesive can also be applied as an at least partly liquid substance—in other words, in a melted state or else in the form of monomers or an only partly polymerized precursor prior to crosslinking—to the structured temporary backing, and can there be converted into the more solid state (such as by cooling or post-crosslinking, for instance), so that in this shaping casting step, as the adhesive solidifies, the groove element is formed in the side face.

The topography of the temporary backing may in this case be formed correspondingly to the groove systems described above, and may have coherent elevations as the ridge element, which may be of any desired construction, rounded or angular for instance. These elevations occupy at least 2% and not more than 65% of the total area of the temporary backing, preferably more than 5% thereof. The non-raised area of the temporary backing may have any customary structures, a planar formation being practical for the majority of applications. In accordance with the desired surface nature of the adhesive layer or with a greater ease of detachability of the temporary backing from the adhesive layer, however, the planar area may also have a micro-scale roughness, which should then, however, be below the height of the ridge element.

The at least one ridge element may be applied to the surface of the temporary backing via any desired shaping and shape-altering techniques. For instance, the structure of the ridge element can be impressed into the surface of the temporary backing by means of an embossing roll, this embossing being carried out where appropriate at high temperatures. Alternatively, the at least one ridge element may be produced by other techniques, as for example in lithographic operations, by wet-chemical etching or laser ablation, in electroplating steps or in a mechanical operation, such as by means of a milling apparatus. If it is intended that a release varnish be applied to the temporary backing, in order to make this backing detach more readily from the adhesive for the purpose of service, then the release varnish can be applied either before the ridge element structure has been produced, or after the structure has been produced. Of course, the release varnish can also be utilized to produce the ridge element, for instance by means of the varnish itself forming the ridge element following its application.

The temporary backing may in this case have such a ridge element on one side, so that for a double-sidedly adhesively bondable 2D element it is necessary to provide each side face of the 2D element with its own temporary backing (a so-called double liner product). Of course, it is also possible for both sides of the temporary backing each to have one or more ridge elements, so that for a double-sidedly adhesively bondable 2D element only a single, double-sidedly structured, temporary backing is required (a so-called single liner product).

Producing the groove element via a temporary backing provided with at least one ridge element can be performed in any suitable way. For instance, the adhesive can be applied directly to the surface of the temporary backing and form the groove element in the process. The adhesive can be applied from aqueous or organic solution, it being possible to remove any solvent residues in a drying section, such as a heating tunnel or IR tunnel. After drying, the heat-activable adhesive takes on the groove element structure that is complementary to the structure of the ridge element.

Of course, however, the heat-activable adhesive can also be applied from the melt to the structured temporary backing. Without further measures, the groove element in this case can only be formed in the adhesive when the viscosity of the melted adhesive is low. In the case of a high melt viscosity, this may additionally require the impressing of the ridge element into the adhesive with subsequent pressured application of the temporary backing onto the adhesive, by means of pressing rolls or pressure rolls, for instance.

Instead, the heat-activable adhesive can also be transfer-laminated onto the structured temporary backing. In order under these conditions to transfer the structure of the ridge element onto the adhesive, the transfer lamination must take place under pressure, using, for example, one or more laminating rolls, rubberized rolls for instance.

Instead of this, or in addition to it, the structure of a ridge element can also be introduced into the adhesive in the course of winding and storage of the 2D element in roll form; for instance, by winding the 2D element provided with the temporary backing onto a roll core under high winding tension, so that, with a high level of efficiency, the structure of the ridge element is modelled complementarily in the adhesive. This method is also suitable for reinforcing weak structuring of the adhesive in the course of storage.

Like the other methods, of course, the methods described above are also suitable, correspondingly, for applying a groove element to the second side face of the 2D element. For this purpose the temporary backing is first of all joined on one side to the 2D element, by one of the methods described above, and then is wound into a roll for storage, in such a way that the heat-activable adhesive on the second side face of the 2D element is pressed against the second ridge element on the second top side of the temporary backing with such strength that, as a consequence of the applied pressure, the second groove element is impressed into the adhesive and, consequently, the second groove element is formed complementarily.

To conclude, the web-like 2D element produced in this way can be brought, by means of diecutting or any other suitable methods, into desired shapes, such as rings, sheets or strips. The total thickness of the heat-activatedly adhesively bonding 2D element, depending on end-use application, is typically situated within a range from approximately 10 μm to approximately 10 mm, more precisely from 25 μm to 1 mm.

By means of the 2D element of the invention produced in this way it is possible in a simple way to obtain bubble-free adhesive bonds, and this is possible even in the case of extensive bonds or non-planar bond areas.

Using heat-activable adhesives, a (planar) adhesive bond is carried out by means of hot lamination. If, for example, a first substrate is to be joined to a second substrate, then in a first step the heat-activable adhesive can be laminated onto the first substrate together with the structured temporary backing, using a roll laminator. Subsequently, the temporary backing is removed and the thus-exposed second adhesive of the 2D element is brought into contact with the second substrate. Lastly, the second bond as well is produced by means of a roll laminator. It is sensible in this case for the direction of movement in which the roll laminator is guided in each case over the composite structure composed of substrate and 2D element to run parallel to the direction of the grooves in the respective groove element, so that, at the same time as lamination, any accumulations of fluid can be drained from the bond area via the groove element and thereby removed.

The individual steps can also be carried out in a different order. For instance, it is possible first to remove the temporary backing and to arrange the first substrate, the 2D element and the second substrate in the desired position relative to one another, before then, finally, passing this assembly, as a relatively loose, sandwich-like assembly, through the hot roll laminator in order to bond both adhesive faces.

Typical in the case of hot laminating operations of this kind, depending on the composition of the adhesives and their activation temperature, is an applied pressure of the hot roll laminator of 1 to 10 bar at a temperature of 40 to 250° C. The transmit speeds are 0.5 to 50 m/min, frequently 2 to 10 m/min. The hot rolls of the roll laminator can be heated from the inside or else by an external heating source. The assembly made up of substrate or substrates and 2D element can alternatively be heated without pressure in a first step—in a heating section, for example—and only then joined, under pressure, by means of a roll laminator which itself is not heated. Another, further possibility is to combine two or more hot roll laminators.

Further advantages and application possibilities are apparent from the working examples which follow. For these examples, two different heat-activable adhesives were prepared, as follows: in a compounder, a solution of a polymer blend in methyl ethyl ketone was prepared. The polymer blend was composed of 50% by weight of a nitrile rubber (Example 1: Breon N36 C80 from Zeon; Example 2: Nipol N1094-80 from Zeon) and 40% by weight of a phenol-novolak resin (Durez 33040), which was blended with 8% by weight of hexamethylenetetramine (Rohm and Haas) and with 10% by weight of a phenolic resole resin (9610 LW from Bakelite). After a kneading time of 20 hours, this gave a solution containing 30% by weight of the polymer blend.

The groove element in the adhesive was formed using a structured temporary backing which had a three-layer construction. As its paper core, the temporary backing contained a glassine paper with a basis weight of 100 g/m². On one side, the paper core was coated directly with low-pressure process polyethylene (HDPE), with a layer thickness of 20 μm. Since the bond strength of the heat-activable adhesive to the temporary backing at room temperature is very low, the backing was coated with a silicone-based adhesion enhancer, with a coatweight of 1.9 g/m², which contained 20% by weight of a sufficiently “blunt” silicone, as a controlled release agent.

Finally, on one side of the temporary backing, a raised ridge element was produced by means of an embossing step. For this purpose, the temporary backing was guided through a nip formed by a structured metal embossing roll and a rubberized roll, in such a way that the polyethylene-coated side of the backing was in contact with the metal embossing roll. The temperature of both rolls was 160° C. and the applied pressure of this engraved-roll laminator was 8 bar/cm.

The metal roll in this arrangement had a milled-in diamond-shape structuring, whose diamonds possessed an edge length of 4 mm. As a result, a groove system was formed on the embossing roll, the grooves of which system were formed continuously and bounded on both sides by diamonds. The width of the grooves was 50 μm and the depth of the grooves was 25 μm. After the unstructured temporary backing had passed through the roll nip with a speed of 0.1 m/min, it had on one side the desired ridge element with raised impressions.

The above adhesives were used to produce a double-sidedly adhering 2D element, provided on both sides with a groove element, in the form of an adhesive transfer tape which contained no permanent backing and whose two side faces carried the same adhesive. For this purpose, the above-described 30% strength solution of the heat-activable adhesive was coated out onto the structured side face of the temporary backing and dried at 100° C. for 10 minutes. Drying gave an adhesive layer having a thickness of 200 μm.

Subsequently, a second temporary backing, formed identically to the first temporary backing, was laminated on, using a hot roll laminator at 120° C. with an applied pressure of 2 bar and a rolling speed of 1 m/min, in such a way that the second structured side face of the second temporary backing was oriented to the exposed, unstructured side of the adhesive. This gave a heat-activatedly adhesively bonding 2D element provided with two temporary backings, in the form of a double liner product.

As reference examples, systems of heat-activatedly adhesively bonding 2D elements were produced which contained the same adhesives (Reference Example 1 with the adhesive from Example 1, Reference Example 2 with the adhesive from Example 2), but with the use as temporary backings—one on either side—of a conventional unstructured glassine release paper from the company Laufenberg with a basis weight of 78 g/m².

To examine the adhesive properties of the resultant heat-activatedly adhesively bonding 2D elements, inventive examples and reference examples were subjected to a variety of test methods.

For this purpose, the temporary backing was removed from one side of a square, heat-activatedly bonding 2D element having a side length of 50 cm, and the bonding element was placed, with the adhesive side thus exposed, onto the pre-cleaned surface of the respective substrate. Subsequently the second temporary backing was peeled off manually and the second substrate was placed onto the second side face, now exposed, of the 2D element. The loose assembly obtained in this way, in the form of a sandwich structure, was run through a hot roll laminator with an applied pressure of 1.5 bar and a laminating speed of 3 m/min, at a laminating temperature of 110° C.

For the purpose of qualitative assessment of an adhesive bond obtained with these 2D elements, a specimen assembly was produced by laminating a transparent polyethylene terephthalate film from the company SKC with a thickness of 50 μm together with an aluminium plate 0.15 mm thick by means of a heat-activatedly bonding 2D element. Following hot lamination, the appearance of the bond was inspected through the transparent film for the incidence of fluid inclusions in the plane of the join.

The peel strength was investigated on a specimen assembly of two polyimide-copper laminates. For this purpose the 2D element was laminated by one of its two side faces to the polyimide side of a laminate formed from a polyimide film and a copper foil. Subsequently the polyimide side of a second laminate composed of a polyimide film and a copper foil was laminated onto the second, exposed side face of the 2D element. In this way a specimen assembly was obtained composed of two polyimide-copper laminates joined to one another via a joint comprising a heat-activatedly bonding 2D element.

This specimen assembly was subsequently brought to a measurement temperature of 23° C. and equilibrated at a humidity of 50%. To measure the peel behaviour, the specimen assembly was pulled apart by means of a tensile load tester (from Zwick GmbH & Co. KG) at a rate of advance of 50 mm/min and at a pulling angle of 180°. The result obtained was the energy per unit area (in N/cm) needed in order to part the bond and to separate the test specimens from one another. The respective data value for the maximum tensile load at this temperature was the average value from three individual measurements in each case.

Lastly, the bond strength was determined in the form of the dynamic shear strength in analogy to DIN EN 1465, using two aluminium sheets each with a thickness of 0.1 mm. The bond strength is produced as the maximum force per unit area (in N/mm²).

In the course of these investigations it was confirmed that Reference Examples 1 and 2, following lamination, always had distinctly visible, fluid inclusions in the bond plane. In Inventive Examples 1 and 2, in contrast, the same adhesives gave a smooth lamination pattern with no such bubbles of fluid.

The results from the determination of the peel strength and the bond strength are shown in Table 1.

TABLE 1

| | Peel strength | Dynamic shear strength |
|---|---|---|
| | [N/cm] | [N/mm²] |
| Inventive Example 1 | 1.2 | 1.5 |
| Reference Example 1 | 0.9 | 1.3 |
| Inventive Example 2 | 1.4 | 1.7 |
| Reference Example 2 | 1.1 | 1.3 |

On the basis of these results it was found that the adhesive properties in the case of Reference Examples 1 and 2 came out consistently lower than in the case of the systems from Inventive Examples 1 and 2. This is attributed to the incidence of fluid accumulations in the bond area in the case of the reference examples, the same accumulations not having been observed in either of the inventive examples. Hence the bond strength overall was always higher in the case of systems which had the groove element in accordance with the invention. The difference in bond strength between the inventive and reference examples that was found in the context of these investigations is, overall, admittedly low, since the fluid inclusions reduce the bond area only by a small amount. Nevertheless, the effect achieved with the use of the groove elements is significant, and serves overall to enhance the stability of an adhesive bond.

1. A two-dimensional element (“2D element”) which bonds adhesively without bubbles under heat activation and has at least one heat-activable adhesive, the two-dimensional element having at least one side face which is oriented parallel to the principal extent of the two-dimensional element and is adapted for the adhesive bonding of the two-dimensional element to a substrate, wherein the side face has a groove element, said groove element comprising at least one groove adapted for the transport of a fluid, the at least one groove being set into the side face in such a way that it is open towards the side face and runs continuously from one edge section of the side face to a further edge section of the side face.

2. The two-dimensional element according to claim 1, wherein the groove element has a multiplicity of grooves.

3. The two-dimensional element according to claim 2, wherein the grooves are connected to one another via one or more intersections.

4. The two-dimensional element according to claim 2, wherein the grooves have a substantially identical depth and a substantially identical width.

5. The two-dimensional element according to claim 2, wherein the grooves have different depths and/or different widths.

6. The two-dimensional element according to claim 1, wherein the width of a groove is at least 100 nm and not more than 2 mm.

7. The two-dimensional element according to claim 1, wherein the total area of the groove element in the side face makes up more than 2% of the total area of the side face and not more than 65% of the total area of the side face, preferably more than 5% of the total area of the side face.

8. The two-dimensional element according to claim 1, wherein the two-dimensional element comprises a permanent backing.

9. The two-dimensional element according to claim 1, wherein the two-dimensional element has a second side face which is disposed opposite the above-described side face, is oriented parallel to the principal extent of the two-dimensional element, and is adapted for adhesive bonding of the two-dimensional element to a second substrate, the second side face having a second groove element which comprises at least one groove adapted for the transport of the fluid, which is set into the second side face in such a way that it is open towards the second side face and runs continuously from one edge section of the second side face to a further edge section of the second side face.

10. The two-dimensional element according to claim 1, wherein the two-dimensional element comprises a temporary backing having a raised ridge element which is shaped complementarily to the at least one groove and which engages into the at least one groove.

11. A method of producing a two-dimensional element according to claim 10, wherein that a heat-activable adhesive is applied to one top side of the temporary backing in such a way that, when the adhesive is applied to the temporary backing, the ridge elements on the top side of the temporary backing form, in the adhesive, the groove element shaped complementarily to the ridge elements, and, in so doing, engage in the at least one groove of the groove element.

12. The method according to claim 11, wherein the two-dimensional element, joined temporarily at one side to the temporary backing, is wound up into a roll, for the purpose of storage, in such a way that on the second side face of the two-dimensional element the heat-activable adhesive is pressed against a second ridge element on a second top side of the temporary backing, disposed opposite the above-described top side, and such that the second groove element, shaped complementarily to the second ridge element, is impressed into the adhesive and engages into the at least one groove of the second groove element.

13. Method of producing a bubble-free adhesive bond by means of a two-dimensional element which bonds adhesively without bubbles under heat activation, according to any one of claim 1, wherein a hot lamination step the two-dimensional element is applied under pressure to the substrate in such a way that fluid enclosed in the bond area between the two-dimensional element and the substrate is drained from the bond area via the groove element.
